(19) United States
(12) Patent Application Publication
(10) Pub. No.: US 2020/0031174 A1
(43) Pub. Date: Jan. 30, 2020

(54) Pneumatic Tire With Textured Annulus

(71) Applicant: COMPAGNIE GENERALE DES ETABLISSEMENTS MICHELIN, Clermont-Ferrand (FR)

(72) Inventors: Jonathan LEJEUNE, Clermont-Ferrand Cedex 9 (FR); Masayohi NOMURA, Clermont-Ferrand Cedex 9 (FR); Olivier MUHLHOFF, Clermont-Ferrand Cedex 9 (FR)

(21) Appl. No.: 16/338,084

(22) PCT Filed: Oct. 9, 2017
(86) PCT No.: PCT/FR2017/052753

§ 371 Date: Mar. 29, 2019

(30) Foreign Application Priority Data
Oct. 11, 2016 (FR) 16/70592

(51) Int. Cl. B60C 13/02

(52) U.S. Cl. CPC B60C 13/02

(57) ABSTRACT

Tire (1) made of rubbery material, comprising a tread (2), sidewalls (3) and shoulders (6) that provide a transition zone between the sidewalls and the tread, and a zone (5) of maximum width of the sidewall, the tire comprising at least one texture (4) along at least one of the sidewalls, the texture (4) comprising a plurality of protruding or recessed elements formed integrally with the sidewall, the texture (4) having a substantially annular shape and being applied to an area covering at least 40% of the surface of the sidewall between the zone (5) of maximum width and the tread (2).

### TECHNICAL FIELD OF THE INVENTION

The present invention relates to tires for vehicles. It relates more particularly to tires having good aerodynamic behaviour.

### PRIOR ART

For several years now, in order to address the multiple issues related to the protection of the environment, the conservation of natural resources, not to mention cost control, there has been a recurrent need to reduce the energy consumption of vehicles, in particular passenger vehicles. One of the options that has been exploited is to reduce the aerodynamic resistance of these vehicles.

The tires with which a passenger vehicle is equipped, and more particularly the tires fitted on the front axle of the vehicle, contribute towards the aerodynamic resistance of this vehicle. It is estimated that the reduction in aerodynamic resistance that can be obtained by optimizing these tires corresponds to about 3% of the total drag of the vehicle; in other words, it may be possible to reduce fuel consumption by changing the design of the tires.

A tire having good aerodynamic performance was presented in the patent U.S. Pat. No. 4,434,830. That tire has better aerodynamic characteristics than conventional tires. The radial cross section of the pneumatic tire has an external contour on each side of its circumferential median plane that extends continuously axially outwards and radially inwards as far as the point where the outside of the surface of each lateral wall crosses a radially extending line which is tangent to the axially outer edge of the rim flange. This embodiment involves a very specific geometry, which greatly reduces the field of application of the solution.

While this tire, when used on a vehicle, effectively exhibits low aerodynamic resistance, it is essential to further improve this performance, in order to meet the increasingly strict requirements of vehicle manufacturers and consumers.

The document U.S. Pat. No. 8,261,793 describes a tire having a plurality of annular ridges arranged with a variable spacing, the spacing decreasing in the radially outward direction. These ridges are provided so as to make operations of moulding and demoulding the tire easier.

The sidewalls of the tires become dirty during their use. They become covered with brake pad powder, dust, and mud. It is the largest adhering and protruding particles that worsen the aerodynamic performance of the tire rotating in its environment, in this case the wing of a car. The deterioration of this performance causes a not insignificant increase in the consumption of the vehicle.

The invention provides various technical means for alleviating these various drawbacks.

### SUMMARY OF THE INVENTION

First of all, a first object of the invention is to provide a tire designed to improve the aerodynamic characteristics of the assembly formed by the vehicle and tires.

A further object of the invention is to reduce the sources of aerodynamic drag at the wheels of the vehicle.

To this end, the invention provides a tire made of rubbery material, comprising a tread and two sidewalls delimiting said tread, each sidewall comprising a zone of maximum width, the tire comprising at least one texture on at least one sidewall, said texture contrasting with the rest of the sidewall, said texture comprising a plurality of protruding or recessed elements formed integrally with said sidewall, the texture being disposed on the sidewall of the tire above the zone of maximum width of the tire, said texture covering at least 20% of the surface of the sidewall above the zone of maximum width and the texture forming a generally annular texture surface, and the mean spacing of the texture elements being between 0.05 and 0.35 mm.

By virtue of this architecture, the tires have an effective means of reducing the adhesion of dirt, especially mud, along the sidewall. Wet mud, which is less adherent, is more easily evacuated, particularly during the rotation of the tire. The aerodynamic qualities of the tire are thus preserved. The arrangement of textures that reduce the adhesion of dirt in the region of the sidewall situated between the zone of maximum width of the tire and tread reduces the creation of disturbances of the airflow. These disturbances increase aerodynamic drag. Specifically, the air streams flowing along the sidewall separate more quickly from the wall and the passage from laminar flow to turbulent flow takes place at a lower speed. These disturbances lead to a worsening in the consumption of the vehicle. By virtue of the above-described tire, these adverse phenomena are greatly attenuated.

Advantageously, the mean spacing of the texture elements is between 0.15 and 0.3 mm and more preferably between 0.18 and 0.25 mm. Such an arrangement makes it possible to reduce even further the adhesion and embedding of particles, dirt, and mud.

According to one advantageous embodiment, the texture has one or more interruption zones, each of the interruption zones exhibiting an angle a of less than 20°, and more preferably less than 5°.

According to one advantageous embodiment, the texture takes up an area of at least 40%, and preferably between 40% and 60% of the surface of the sidewall radially on the outside of the zone of maximum width.

A large area needs to be covered by the textures in this critical zone so as to allow a notable effectiveness.

According to a further advantageous embodiment, markings are incorporated in the texture. These markings preferably have a luminance that is at least 5 points higher, and preferably at least 12 points higher.

Advantageously, the elements of the texture are recessed into the surface of the sidewall of the tire.

This arrangement is particularly favourable for optimizing the aerodynamic characteristics of the tire.

The mean height of the texture is advantageously between 0.2 and 1 mm, preferably between 0.25 and 0.6 mm and more preferably between 0.3 and 0.5 mm.

According to an another embodiment, the elements of the texture are in a housing recessed into the surface of the sidewall, such that the axially outer ends of the elements of the texture are set back from the surface of the sidewall of the tire, or substantially flush with the surface of the tire.

According to another advantageous embodiment, all or some of the protruding elements form strands, said strands being distributed in the pattern at a density at least equal to four strands per square millimetre (mm²), each strand having a mean cross section of between 0.0005 mm² and 1 mm² and more preferably a mean cross section of between 0.008 and 0.15 mm².

According to one exemplary embodiment, all or some of the protruding elements form mutually parallel blades, the spacing of the blades in the pattern being at most equal to 0.5 mm, each blade having a mean width of between 0.02 mm and 0.35 mm, and more preferably between 0.05 mm and 0.1 mm.

According to another exemplary embodiment, all or some of the protruding elements form parallelepipeds having a side length of between 0.05 mm and 0.3 mm and a height of between 0.05 mm and 0.5 mm, the distance between two adjacent parallelepipeds in the texture being between 0.02 mm and 0.35 mm.

According to yet another exemplary embodiment, all or some of the recessed elements form mutually parallel striations, the spacing of the striations in the pattern being at most equal to 0.5 mm, each striation having a mean width of between 0.02 mm and 0.35 mm, and more preferably between 0.05 mm and 0.1 mm.

In another exemplary embodiment, all or some of the recessed elements form cavities distributed through the texture at a density at least equal to four cavities per square millimetre (mm²), each cavity having a mean cross section of between 0.0005 mm² and 1 mm², and more preferably a mean cross section of between 0.008 and 0.15 mm².

According to another exemplary embodiment, all or some of the recessed or protruding elements exhibit mutually variable shapes and distances.

Advantageously, the texture has a lightness referred to as first lightness (L*1) and the rest of the sidewall has a lightness referred to as second lightness (L*2), the difference in lightness between the lightness L*1 and the lightness L*2 being at least 5 units (of lightness on a scale ranging from 0 to 100).

In such an architecture, the textured surfaces absorb light. By contrast, the smoother surfaces of the sidewall allow better reflection of the light. This creates a contrast between the two surfaces and makes the textured zone more visible.

Such a difference between levels of lightness makes it possible to ensure a clear difference in the level of contrast. This contrast effect can advantageously be used to incorporate visual or graphic elements with a minimized size, thereby making it possible to reduce the impact thereof on the aerodynamics of the tire.

### Definitions

A “tire” means all types of resilient tread, whether or not it is subjected to an internal pressure.

A “rubbery material” means a diene elastomer, that is to say, in a known way, an elastomer which is based, at least partially (i.e. is a homopolymer or a copolymer), on diene monomers (monomers bearing two conjugated or non-conjugated carbon-carbon double bonds).

The “tread” of a tire means a quantity of rubbery material delimited by lateral surfaces and by two main surfaces, one of which, referred to as the tread surface, is intended to come into contact with a road surface when the tire is being driven on. The tread comprises a plurality of cuts extending over at least one of the lateral surfaces.

The “sidewall” of a tire means a part of the lateral surface of the tire that is disposed between the tread of the tire and a bead of this tire, starting from the ends of the cuts in the tread and extending as far as the bead.

A “texture” means an organized arrangement of a plurality of elements, all or some of the elements in the arrangement being the repetition of one and the same basic element, for example a strand or a lamella.

A “strand” means a filiform element, the height of which is at least equal to twice the diameter of a disc having the same surface area as the mean cross section of the strand.

“Lamellae” means elongate strands which have a length at least equal to twice their height.

“Lightness” or “luminance” means the parameter which characterizes a surface to reflect light to a greater or lesser extent. Lightness is expressed using a scale that ranges from 0 to 100 according to the L*a*b* colour model established by the CIE (International Commission on Illumination) in 1976. The value 100 represents white or total reflection; the value 0 represents black or total absorption.

### DESCRIPTION OF THE FIGURES

All the embodiment details are given in the following description, which is supplemented by FIGS. 1A to 9, which are given solely by way of non-limiting examples and in which:

FIGS. 1A to 1D are partial schematic depictions of tires showing the tread and various exemplary embodiments of external sidewalls;

FIGS. 2 and 3 are schematic depictions of a cross section of sidewall texture elements illustrating various examples of heights of textures with respect to the wall of the sidewall;

FIG. 4 shows a part of the texture of the sidewall according to a first exemplary embodiment in which the texture has protruding elements in the form of strands;

FIG. 5 shows a part of the texture of the sidewall according to a second exemplary embodiment in which the texture has protruding elements in the form of lamellae;

FIG. 6 shows a part of the texture of the sidewall according to a third exemplary embodiment in which the texture has protruding elements in the form of parallelepipeds;

FIG. 7 shows a part of the texture of the sidewall according to a fourth exemplary embodiment in which the texture has protruding elements in which the shapes and the distances between protruding elements are variable;

FIG. 8 shows a part of the texture of the sidewall according to a fifth exemplary embodiment in which the texture has recessed elements which are conical in this example;

FIG. 9 shows an enlarged view of a cavity of a recessed element of the texture from FIG. 8.

### DETAILED DESCRIPTION OF THE INVENTION

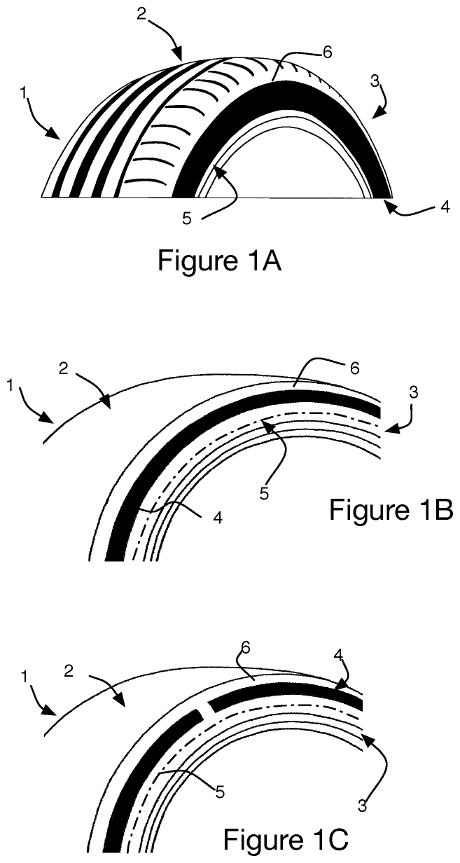

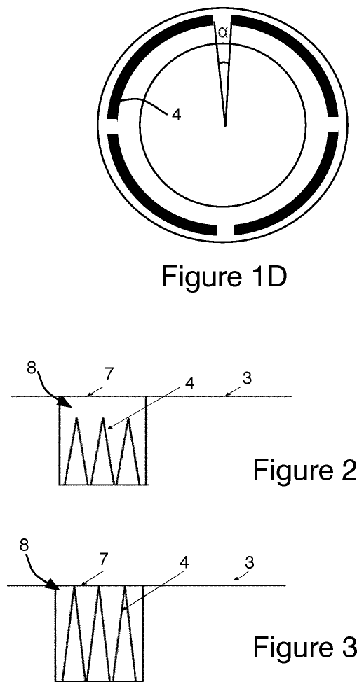

FIGS. 1A to 1D illustrate exemplary embodiments of a tire according to the invention. In the figures, the tire 1 comprises a tread 2 surrounded on either side by sidewalls 3. The tread 8 provides a surface for contact with the ground. The sidewalls generally have a profile curved axially towards the outside of the tire. This type of profile makes it possible to define a zone 5 of maximum width, forming a crown, as indicated in FIGS. 1A to 1D. The surface between this crown and the start of the tread 2 comprises a texture 4 specifically designed to reduce the adhesion of particles, dirt, mud, and other foreign matter to the tire.

Specifically, the inventors have found that particles adhering to the sidewalls of the tires, when they are situated substantially between the shoulder of the tire and the equator on the external sidewall, starting from a protruding size of 0.2 mm, create local disturbances of the airflows. The air streams separate more quickly along the sidewall of the tire and the passage between laminar flow and turbulent flow occurs at a reduced speed, resulting in worsening of the consumption of the vehicle by an increase, inter alia, in the ventilation torque. Moreover, the speed at which the upper shoulder of the tire travels is almost twice the speed of the vehicle. For a vehicle travelling at 100 km/h, the part of the sidewall at which the air streams begin to separate travels at about 180 km/h, whence the impact of the phenomenon on consumption.

Furthermore, the inventors have also noticed that mud is easier to evacuate when it is still wet, before drying. The tire according to the invention takes these different parameters into account and aims notably to incorporate an optimized texture in order to minimize the adhesion of wet mud.

The textured surface is therefore situated between the bottom of the tread pattern of the tread 2 at the shoulder 6 of the tire (or at the end of the last notches) and the equator of the tire (or the axially outermost part of the sidewalls).

In order to optimize the efficiency, the textured surface has a substantially annular shape and is applied to an area covering at least 20%, and more preferably between 40 and 60%, even more preferably between 60% and 80% of the surface of the sidewall situated between the zone 5 of maximum width and the tread 2.

The arrangement of the texture 4 can also be optimized in the angular plane, with an angular coverage extending over at least 270 degrees, preferably over at least 300 degrees, and more preferably over at least 330 degrees.

In the examples illustrated, the texture surface 4 is arranged angularly either continuously, as shown in FIGS. 1A and 1B, or discontinuously, as shown in the examples in FIGS. 1C and 1D.

In the particular case of the sidewalls with a protective ridge (short sidewalls of high performance tires), the low point of the zone to be considered is the axially outermost point when the tire is not mounted on its rim. One such example is illustrated in FIG. 1A.

Given that the tread 2 and the shoulder 6 of the tire self-clean when the vehicle is being driven by repeated contact with the road, it is possible for these zones not to have a texture.

Below the equator 5 (the axially outermost part), when travelling at high speed, air streams are separated from the sidewall. The presence of textures would thus have little or no impact on the aerodynamic characteristics.

By contrast, at intermediate speeds, the air streams can separate beneath the equator of the tire. Therefore, it may prove advantageous to provide an extension of the textured surface, if the profile of the sidewall allows this, to 20 mm below the equator for a passenger vehicle tire, 40 mm for a van tire and to 60 mm below the equator for a tire intended to equip vehicles of the heavy-duty type.

Preferably, at least the sidewall on the outside of the vehicle contains this texture.

FIG. 2 schematically illustrates a partial cross section of the elements of the texture 4. The texture elements are in a cavity 8. It can be seen that the tops of the texture elements are set back from the surface 7 of the sidewall 3 of the tire. For example, the mean depth of the texture is between 0.2 and 1 mm, preferably between 0.25 and 0.6 mm and more preferentially between 0.3 and 0.5 mm.

FIG. 3 illustrates another type of arrangement, in which the elements of the texture are flush with the surface 7 of the sidewall 3 of the tire.

In order to optimize the properties of non-adhesion of the texture elements, the mean spacing of the texture elements is between 0.05 and 0.35 mm, preferably between 0.15 and 0.3 mm and more preferably between 0.18 and 0.25 mm. Depending on the embodiment, the spacing can be fixed or variable.

According to a preferred arrangement, the texture 4 has a lightness referred to as first lightness L*1. The rest of the sidewall 3 has a lightness referred to as second lightness L*2. The difference in lightness between the lightness L*1 and the lightness L*2 is preferably at least 5 units.

According to various embodiment variants, markings are incorporated in the texture. These markings have a luminance that is at least 5 points higher, and preferably at least 12 points higher than the rest of the texture. This difference in lightness makes it possible to render the markings clearly visible. Such a feature is particularly advantageous when the tire is in a context in which visibility is limited. The markings are preferentially embedded in the texture, or flush therewith; they do not protrude from the texture.

The appropriate device for measuring the lightness is a Konica-Minolta CM 700D spectrocolorimeter (registered trade mark). This device is suitable for measuring:
the lightness L*1, L*2 of the different zones;
a component a* which defines a first colour shade between red and green;
a component b* which defines a second colour shade between yellow and blue.

Said device is positioned on the part of the tire to be measured and said device gives the values of the three parameters L*, a* and b* relative to the surface measured. These measurements are taken using the “SCI” (specular component included) mode, set at an angle of 10° and with a D65 type light setting (setting as defined by the International Commission on Illumination, CIE). By virtue of this device, the lightness of the textures 4 of the sidewall is measured, this then being compared with the lightness of the texture-free parts of the sidewall.

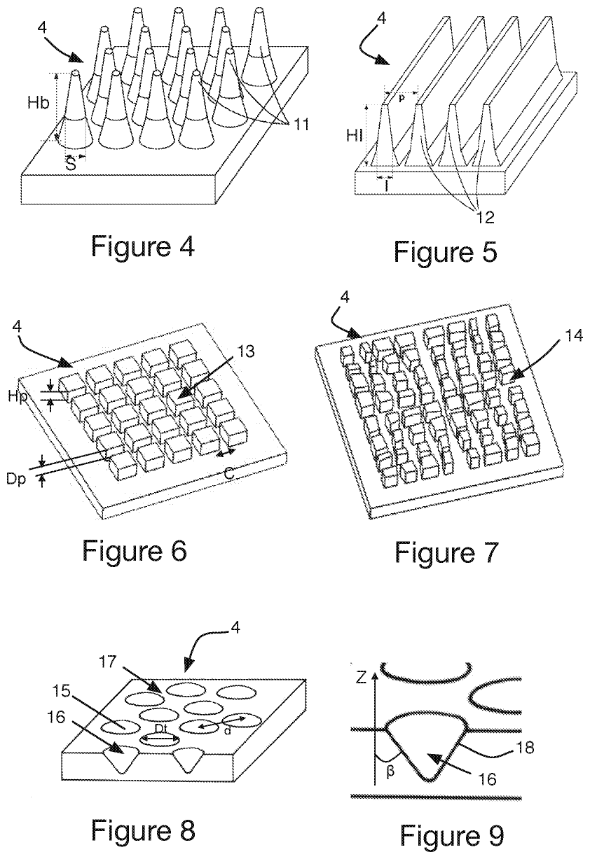

FIGS. 4 to 9 illustrate examples of textures 4 that can be disposed on the generally annular texture surface according to the invention.

FIG. 4 illustrates an embodiment in which the texture has a plurality of strands 11. The strands 11 are distributed through the texture at a density at least equal to one strand per mm2, each strand having a mean cross section S of between 0.0005 mm² and 1 mm². It will be noted that the mean cross section of each strand corresponds to the mean of the cross sections S measured at regular intervals from the base of the strand. The strands have a conical overall shape with a cross section that decreases over the height Hb of these strands.

FIG. 5 illustrates an embodiment in which the texture 4 has a plurality of mutually parallel blades 12, the spacing of the blades 12 in the texture being at most equal to 0.5 mm, each blade 12 having a mean width of between 0.02 mm and 0.5 mm. It will be noted that the mean width corresponds to the mean of the widths I measured at regular intervals over the height HI of the blade, the height of each blade being between 0.05 and 0.5 mm.

In another embodiment variant, the texture has a combination of strands 11 and/or blades 12. The invention is not limited to the examples described and shown and various modifications can be made thereto without departing from its scope. Thus, according to another non-limiting embodiment variant, the blades 12 in FIG. 5 can be discontinuous. They have a flat part between one another. They can also have cross-sectional differences between one another. In addition, the blades can have curves or angles, notably along their length. They can also have a variable length.

In the example in FIG. 6, the textures have a parallelepipedal cross section 13 having a side length C of between 0.05 mm and 0.5 mm and a height Hp of between 0.05 mm and 0.5 mm, the distance Dp between two adjacent cavities in the texture being between 0.05 mm and 0.5 mm. Alternatively, the cross section of the textures may be circular, polygonal (for example hexagonal). With the square or polygonal structures, it is possible to more easily organize the elements with respect to one another so as to limit the surface area of the intermediate zones between the elements. In the variant in FIG. 7, the elements 14 have mutually variable shapes and distances. This variant makes it possible to render the details of the texture 4 less visible.

FIG. 8 illustrates a texture 4 according to another non-limiting embodiment variant. In this variant, the texture is formed by a plurality of cavities 16. The cavities 16 are in this case in the form of cones which extend into the depth of the surface and open onto this surface, forming circular openings 15. The cavities 16 thus have a cross section which decreases with depth. It will be noted that, in this variant, the openings 15 of the cavities 16 are not in contact. The openings 15 are separated by intermediate zones 17. Moreover, the openings 15 are distributed regularly such that the distance d between each opening 15 is similar overall. FIG. 9 is an enlarged view of the texture in FIG. 8. In this case, all or some of the cavities have at least one wall 18 which, in cross section, forms an angle β 3 of between 10° and 60° with respect to a direction Z perpendicular to the texture 4.

For the texture elements forming strands or parallelepipeds or cavities, each of the texture elements can be included in a virtual circle with a diameter less than or equal to 1 mm. These dimensions make it possible to optimize the anti-dirt properties of the textures, and therefore the aerodynamic performance of the tires.

For the texture elements forming blades or striations, each of the texture elements is advantageously oriented at an angle of between 20 and 90° with respect to the circumferential direction. This geometry makes it possible to optimize the moulding characteristics of tires by facilitating the evacuation of air in the mould, and also the anti-dirt properties of the textures, and therefore the aerodynamic performance of the tires.

### REFERENCE NUMERALS EMPLOYED IN THE FIGURES

1 Tire
2 Tread
3 Sidewall
4 Texture
5 Zone of greatest width of the sidewall
6 Shoulder
7 External surface of the sidewall
8 Housing
11 Strands
12 Blades
13 Parallelepipedal cross section
14 Protruding elements
15 Openings
16 Cavities
17 Intermediate zones
18 Cavity wall

1. A tire made of rubbery material, comprising a tread and two sidewalls delimiting said tread, each said sidewall comprising a zone of maximum width, the tire comprising at least one texture on at least one sidewall, said texture contrasting with the rest of the sidewall, said texture comprising a plurality of protruding or recessed elements formed integrally with said sidewall, wherein the texture is disposed on the sidewall of the tire above the zone of maximum width of the tire, said texture covering at least 20% of the surface of the sidewall above the zone of maximum width, and in that wherein the texture forms a generally annular texture surface, and wherein the mean spacing of the texture elements is between 0.05 and 0.35 mm.

2. The tire according to claim 1, wherein the mean spacing of the texture elements is between 0.15 and 0.3 mm.

3. The tire according to claim 1, wherein the texture has a lightness referred to as first lightness and the rest of the sidewall has a lightness referred to as second lightness, wherein the difference in lightness between the first lightness and the second lightness is at least 5 units.

4. The tire according to claim 1, wherein the texture has one or more interruption zones, each of the interruption zones exhibiting an angle α of less than 20°.

5. The tire according to claim 1, wherein the texture takes up an area of at least 40%, of the surface of the sidewall radially on the outside of the zone of maximum width.

6. The tire according to claim 1, wherein the mean height of the texture is between 0.2 and 1 mm.

7. The tire according to claim 1, wherein the elements of the texture are in a housing recessed into the surface of the sidewall, such that the ends of the texture are set back from the surface of the sidewall of the tire.

8. The tire according to claim 1, wherein all or some of the protruding elements form strands, said strands being distributed in the pattern at a density at least equal to four strands per square millimetre (mm²), each strand having a mean cross section of between 0.0005 mm² and 1 mm².

9. The tire according to claim 1, wherein all or some of the protruding elements form mutually parallel blades, each blade having a mean width of between 0.02 mm and 0.35 mm.

10. The tire according to claim 1, wherein all or some of the protruding elements form parallelepipeds having a side length of between 0.05 mm and 0.3 mm and a height of between 0.05 mm and 0.5 mm, the distance between two adjacent parallelepipeds in the texture being between 0.02 mm and 0.35 mm.

11. The tire according to claim 1, wherein all or some of the recessed elements form mutually parallel striations, each striation having a mean width of between 0.02 mm and 0.35 mm.

12. The tire according to claim 1, wherein all or some of the recessed elements form cavities distributed through the texture at a density at least equal to four cavities per square millimetre (mm²), each cavity having a mean cross section of between 0.0005 mm² and 1 mm².

13. The tire according to claim 1, wherein all or some of the recessed or protruding elements exhibit mutually variable shapes and distances.

14. The tire according to claim 1, wherein the mean spacing of the texture elements is between 0.18 and 0.25 mm.

15. The tire according to claim 1, wherein the texture has one or more interruption zones, each of the interruption zones exhibiting an angle a of less than 20°.

16. The tire according to claim 1, wherein the texture takes up an area of at least between 40% and 60% of the surface of the sidewall radially on the outside of the zone of maximum width.

17. The tire according to claim 1, wherein the mean height of the texture is between 0.3 and 0.5 mm.

18. The tire according to claim 1, wherein the elements of the texture are in a housing recessed into the surface of the sidewall, such that the ends of the texture are substantially flush with the surface of the tire.
